(19) United States
(12) Patent Application Publication
(10) Pub. No.: US 2008/0289586 A1
(43) Pub. Date: Nov. 27, 2008

(54) Device for shielding an animal

(76) Inventor: David L. O'Connor, Bellingham, MA (US)

Correspondence Address: KRIEGSMAN & KRIEGSMAN, 30 TURNPIKE ROAD, SUITE 9, SOUTHBOROUGH, MA, 01772, US

(21) Appl. No.: 12/150,005

(22) Filed: Apr. 24, 2008

Related U.S. Application Data
(60) Provisional application No. 60/925,706, filed on May 24, 2007.

(51) Int. Cl. A01K 13/00; A45B 11/02

(52) U.S. Cl. 119/850; 135/16

(57) ABSTRACT

A device for shielding an animal from precipitation and sunlight includes a harness which is releasably secured to the animal and an umbrella which is removably attached to the harness. The harness includes an elongated dorsal strip which lies along the spine of the animal, a tubular holder which extends away from the top surface of the dorsal strip, a posterior strap which wraps tightly around the abdomen of the animal and an anterior strap which wraps tightly around a collar worn on the neck of the animal. The umbrella includes an elongated handle which, at one end, is dimensioned for fitted insertion into the holder and which, at the other end, is fixedly coupled to an enlarged, foldable canopy. The enlarged canopy includes an enlarged, generally rectangular sheet of water-proof fabric and a frame secured to the sheet to provide structural rigidity.

### CROSS-REFERENCE TO RELATED APPLICATIONS

The present application claims the benefit under 35 U.S.C. 119(e) of U.S. provisional Patent Application Ser. No. 60/925,706, filed May 24, 2007, the disclosure of which is incorporated herein by reference.

### BACKGROUND OF THE INVENTION

The present invention relates generally to shielding devices and more particularly to portable shielding devices such as umbrellas.

An umbrella is a well known portable device that is commonly used to shield people from common weather-related conditions, such as rain, snow, wind, sunlight and the like. Traditionally, an umbrella includes an elongated handle, often cylindrical in shape, on which is mounted at one end a collapsible canopy. When expanded open, the canopy serves as an enlarged barrier against precipitation, sunlight and the like. When not in use, the canopy can be collapsed, thereby rendering the umbrella more compact for storage.

Umbrellas are typically constructed with a canopy which is generally circular when expanded open. In this manner, the canopy is properly dimensioned to adequately shield a person standing thereunder.

However, it should be noted that the design of traditional umbrellas has been found to be ill-suited for use in shielding four-legged animals from environmental elements. Specifically, a circular canopy often fails to the protect the entirety of an animal of considerable length. Furthermore, because an animal can not hold the handle of an umbrella, additional means for attaching the umbrella to the animal is required. As a result, it has been found that animals which have an aversion to certain elements, such as rain, are often precluded from partaking in outdoor activities, which is highly undesirable.

### SUMMARY OF THE INVENTION

It is an object of the present invention to provide a novel device for shielding an animal from common environmental conditions, such as precipitation and sunlight.

It is another object of the present invention to provide a device as described above which is dimensioned to shield the entirety of the animal.

It is yet another object of the present invention to provide a device as described above which can be fittingly secured to the animal.

It is still another object of the present invention to provide a device as described above which is lightweight and portable in nature.

It is yet still another object of the present invention to provide a device as described above which has a limited number of parts, is easy to use and is inexpensive to manufacture.

Accordingly, there is provided a device for shielding an animal, the device comprising (a) a harness adapted to be releasably secured to the animal and an umbrella coupled to the harness.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a perspective view of an animal shielding device constructed according to the teachings of the present invention, the device being shown mounted on a dog;

FIG. 2 is an enlarged, top perspective view of the harness shown in FIG. 1, the harness being shown with its anterior and posterior straps open;

FIG. 3 is an enlarged, bottom perspective view of the umbrella shown in FIG. 1;

FIG. 4 is a top plan view of the umbrella shown in FIG. 1; and

FIG. 5 is a side plan view of the umbrella shown in FIG. 1, the umbrella being shown in a partially collapsed state.

### DETAILED DESCRIPTION OF THE PREFERRED EMBODIMENT

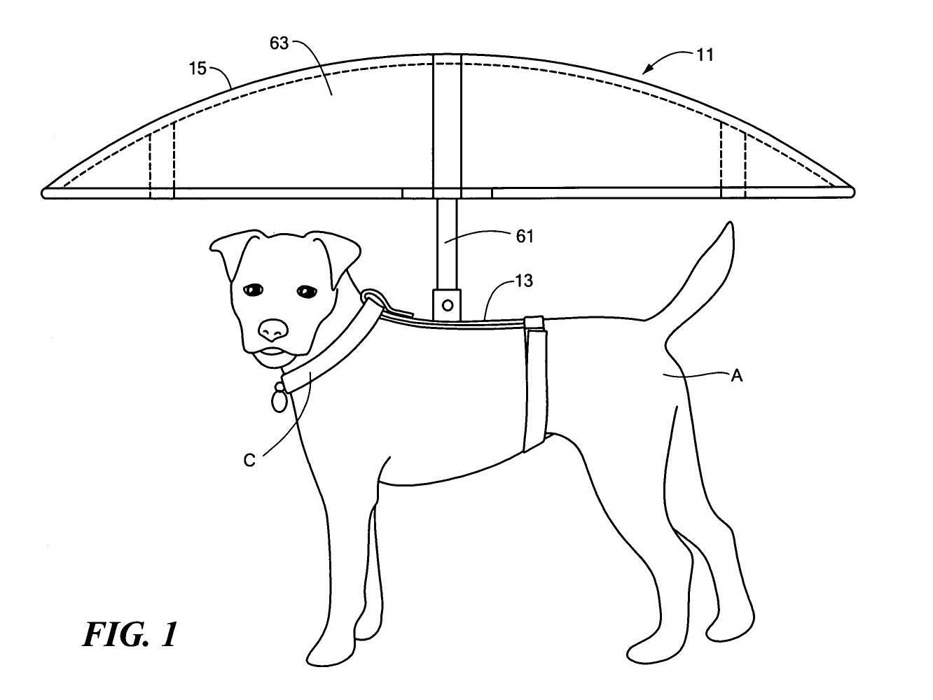

Referring now to FIG. 1, there is shown a device for shielding an animal from weather-related environmental conditions, such as rain, snow, wind and/or sunlight, the device being constructed according to the teachings of the present invention and identified generally by reference numeral 11. As will be described further in detail below, device 11 is designed as a lightweight, portable device which is adapted to be removably mounted on an animal A.

Animal A is represented in FIG. 1 as being in the form of a dog. However, it should be noted that device 11 is not limited for use with dogs. Rather, it is to be understood that the present invention could be similarly configured for mounting on alternative types of four-legged animals, such as cats, horses and the like, without departing from the spirit of the present invention.

Device 11 comprises a harness 13 which is adapted for releasable securement to animal A and an umbrella 15 which is removably coupled to harness 13.

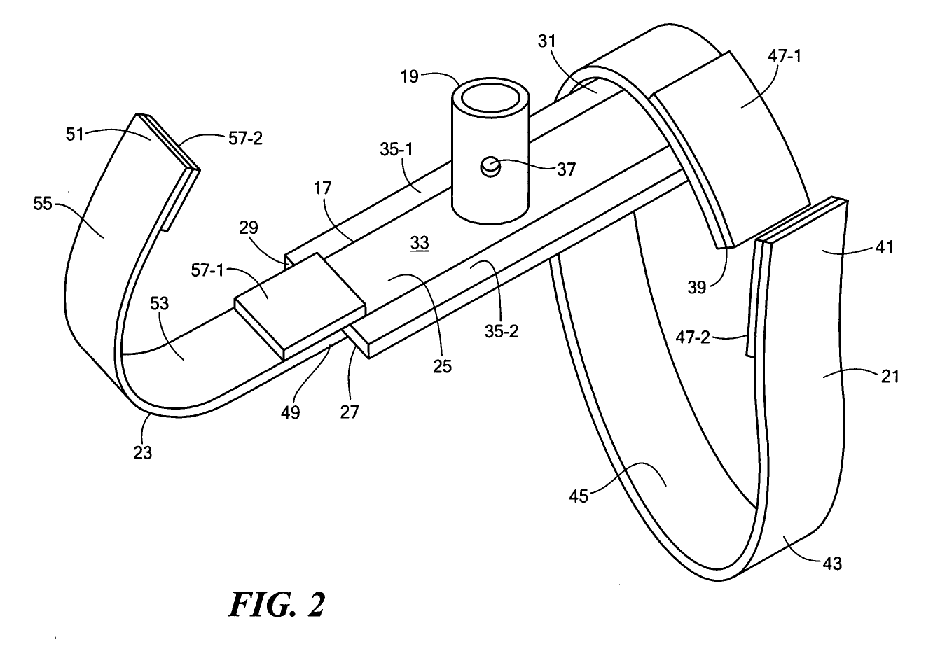

Referring now to FIG. 2, harness 13 comprises a dorsal strip 17, an umbrella holder 19 formed on dorsal strap 17, a transverse posterior strap 21 connected to the rear end of dorsal strip 17 and a co-linear anterior strap 23 connected to the front end of dorsal strip 17.

Dorsal strip 17 is an elongated, flattened support, or base, which is sized and shaped to extend longitudinally along at least a portion of the spine of animal A, strip 17 comprising a substantially flat top surface 25, a substantially flat bottom surface 27, a first end 29 and a second end 31.

Dorsal strip 17 is represented herein as comprising a widened, longitudinal, center portion 33 which is constructed of a rigid material, such as a hardened plastic, in order to provide the necessary structural support for harness 13. In addition, dorsal strip 17 includes a pair of wings 35-1 and 35-2 which extend longitudinally along opposing sides of center portion 33, each wing 35 being constructed of a stretchable, weave-like material, such as an elastomeric fiber, so as to closely conform to the particular contours of the back of animal A, which is highly desirable.

Holder 19 is constructed as a rigid, hollow, tubular member, approximately 2 to 6 inches in length, which extends at a right angle away from top surface 25 of dorsal strip 17 at a location between first end 29 and second end 31. Holder 19 is generally circular in transverse cross-section and is dimensioned to fittingly receive the handle of umbrella 15, as will be described further in detail below. Preferably, holder 19 is shaped to define a small, circular opening 37 along its length, opening 37 being dimensioned to fittingly receive a spring-biased button on umbrella 15, thereby establishing a lockable interconnection between harness 13 and umbrella 15, which is highly desirable.

Posterior strap 21 is preferably constructed as an elongated strip of stretchable material, such as an elastomeric fiber, which is fixedly connected to second end 31 of dorsal strip 17, posterior strap 21 comprising a first end 39, a second end 41, a top surface 43 and a bottom surface 45. First end 39 of posterior strap 21 is connected to second end 31 of dorsal strip 17 such that the remainder of posterior strap 21 extends at a transverse angle relative to the longitudinal axis of dorsal strip 17. In this manner, it is to be understood that posterior strap 21 can be formed into a closed loop that is dimensioned to wrap tightly around the abdomen, or belly, of animal A, as shown in FIG. 1. Preferably, complementary releasable fasteners 47-1 and 47-2 (e.g., hook and loop type fasteners) are provided on top surface 43 at first end 39 and bottom surface 45 at second end 41, respectively, so as to enable posterior strap 21 to be securely retained as a closed loop around the abdomen of animal A. In this manner, posterior strap 21 assists in holding harness 13 in place in its mounted position on animal A, which is highly desirable.

Anterior strap 23 is similarly preferably constructed of an elongated strip of stretchable material, such as an elastomeric fiber, which is fixedly connected to first end 29 of dorsal strip 17, anterior strap 23 comprising a first end 49, a second end 51, a top surface 53 and a bottom surface 55. First end 49 of anterior strap 23 is connected to first end 29 of dorsal strip 17 such that the remainder of anterior strap 23 extends at a co-linear angle relative to the longitudinal axis of dorsal strip 17. In this manner, it is to be understood that anterior strap 23 can be folded upon itself into a tight closed loop around a collar C worn on the neck of animal A, as shown in FIG. 1. Preferably, complementary releasable fasteners 57-1 and 57-2 (e.g., hook and loop type fasteners) are provided on top surface 53 at first end 49 and top surface 53 at second end 51, respectively, so as to enable anterior strap 23 to be securely retained around collar C. In this manner, anterior strap 23 assists in holding harness 13 in place in its mounted position on animal A, which is highly desirable.

As noted above, harness 13 is not limited for use with any particular size, breed or type of animal A. Accordingly, it is to be understood that the dimensions and/or construction of harness 13 could be modified, as deemed necessary, to allow harness 13 to fit more properly on the different builds of various animals without departing from the spirit of the present invention.

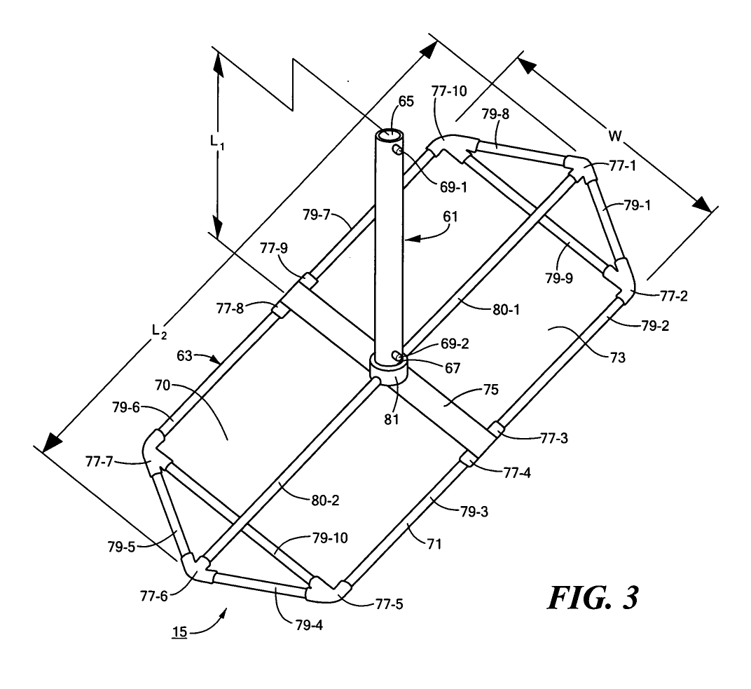

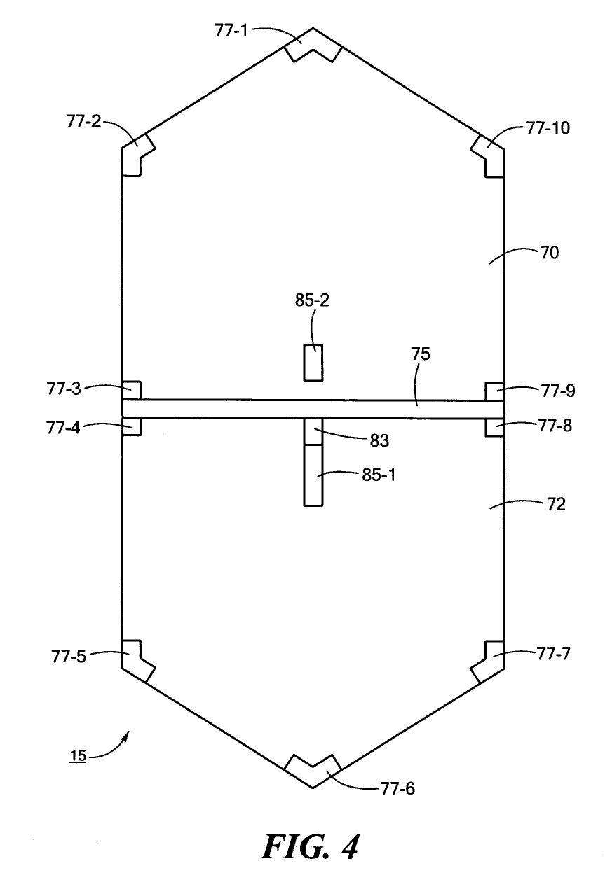

Referring now to FIGS. 3-5, umbrella 15 comprises an elongated handle 61 and a foldable canopy 63 coupled to one end thereof.

Handle 61 is represented herein as being in the form of an elongated tube, or post, which is constructed of a rigid and durable material, such as a rigid plastic, lightweight metal or wood. Preferably, handle 61 has a length L, of approximately 12 inches. However, it is to be understood that length L, could be increased or decreased without departing from the spirit of the present invention.

Handle 61 includes a first end 65 and a second end 67. First end 65 of handle 61 is sized and shaped to be fittingly inserted into holder 19 in harness 13, as will be described further below. Second end 67 of handle 61 is fixedly coupled to foldable canopy 63.

Handle 61 additionally includes a bottom spring 69-1 proximate first end 65 and a top spring 69-2 proximate second end 67. Each spring 69 is represented herein as a push button which is naturally biased outward by a spring (not shown). As will be described further below, with first end 65 inserted into holder 19, bottom spring 69-1 projects through opening 37 to retain umbrella 15 mounted on harness 13.

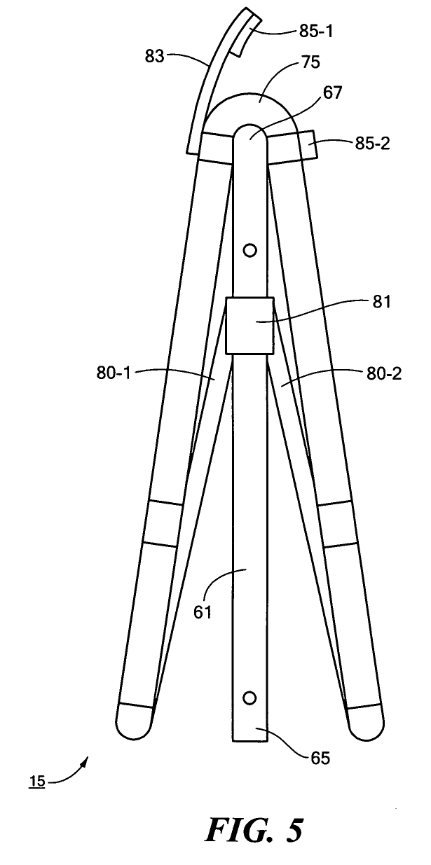

Foldable canopy 63 is preferably constructed as an enlarged protective shield which can be disposed between an open position, as shown in FIGS. 1, 3 and 4, and a closed position, as shown in FIG. 5.

Canopy 63 comprises an enlarged sheet of water-proof fabric 70 and a rigid frame 71 which serves, among other things, to provide sheet of water-proof fabric 70 with the requisite structural rigidity.

Sheet of water-proof fabric 70 is preferably constructed from any material which is well-suited to deflect precipitation, such as nylon. As shown herein, sheet of water-proof fabric 70 has a generally hexagonal configuration, with a length L₂ of approximately 24 inches and a width W of approximately 7 inches. As can be appreciated, sheet of water-proof fabric 70 is specifically designed with an elongated, generally rectangular shape in order to properly shield the entire body of four-legged animal A from weather-related elements, which is highly desirable.

Sheet of water-proof fabric 70 includes a top surface 72, a bottom surface 73 and a strip of reinforced material 75 which extends transversely across its center section. As can be appreciated, strip 75 serves as a fold line through which sheet of water-proof fabric 70 can be folded in half, as seen most clearly in FIG. 5.

As seen most clearly in FIG. 3, frame 71 comprises a plurality of connectors 77-1 thru 77-10 which are permanently secured to sheet of water-proof fabric 70 at various points along its periphery, an array of flexible support members, or ribs, 79-1 thru 79-10 which are affixed to connectors 77 to provide canopy 63 with the necessary structural rigidity, a pair of stretchers 80-1 and 80-2 which assist in the opening and closing of canopy 63, and a runner, or collar, 81 which is slidably mounted over handle 61.

Each support member 79 is preferably constructed of a strong and durable material, such as a flexible wire or plastic. As can be seen, support members 79-1 thru 79-8 extend along the periphery of sheet 70 and are attached to connectors 77 to rigidly maintain the outer shape of canopy 63. In addition, support members 79-9 and 79-10 extend transversely across bottom surface 73 of sheet 70 at opposing ends thereof and attach to corresponding connectors 77 to assist in maintaining the structural rigidity of the inner portion of sheet 70.

Opposing stretchers 80-1 and 80-2 extend longitudinally across bottom surface 73, each of stretchers 80-1 and 80-2 pivotally attaching, at one end, to corresponding connectors 77-1 and 77-6, respectively, and fixedly attaching, at the other end, to movable collar 81. As will be described further below, with canopy 63 disposed open, stretchers 80 apply a force onto support members 79 which cause support members 79 to bow slightly in a convex manner, thereby expanding sheet 70 fully open.

As noted above, collar 81 is adapted for slidable displacement along handle 61. As collar 81 is slid down handle 61 towards first end 65, the inner end of each stretcher 80 similarly moves down handle 61 towards first end 65. This downward displacement of stretcher 80 in turn serves to withdraw the tension applied by stretchers 80 onto bowed support members 79, thereby enabling support members 79 to straighten to the extent that is necessary for canopy 63 to be folded in half through strip 75.

With canopy 63 folded in half, a strap 83 can be used to retain canopy 63 closed. Specifically, strap 83 is affixed at one end to top surface of 72 of sheet 70. The free end of strap 83 and top surface 72 of sheet 65 are in turn provided with complementary releasable fasteners 85-1 and 85-2, respectively. Accordingly, by pulling strap 83 tightly over folded sheet 70 until complementary fasteners 85 suitably engage, canopy 63 is retained closed, which is useful for storage purposes.

With strap 83 released, canopy 63 can be opened by displacing collar 81 up along handle 61 towards second end 67. As collar 81 approaches second end 67, stretchers 80 apply an outward force onto straightened support members 79 which, in turn, causes support members 79 to bow in a convex manner and thereby hold sheet 70 taut in its open position. It should be noted that with collar 81 positioned at second end 67, top spring 69-2 resiliently expands outward and engages 81 so as to prevent downward displacement thereof. Accordingly, in the absence of the application of an inward force thereon, top spring 69-2 serves to retain canopy 63 in its open position.

It should be noted that umbrella 15 differs from traditional umbrellas in at least the two following ways.

As a first distinction, umbrella 15 comprises a canopy 63 which is elongated and generally rectangular. To the contrary, traditional umbrellas typically include canopies which are generally circular in design. As can be appreciated, the elongated, rectangular design of canopy 63 renders umbrella 15 more suitably dimensioned to shield a four-legged animal from precipitation, which is a principal object of the present invention.

As a second distinction, umbrella 15 includes a canopy 63 that is designed to fold in half into its closed position. To the contrary, traditional umbrellas include canopies which collapse about a center point when closed. As can be appreciated, canopy 63 closes through folding, rather than collapsing, due to its unique, generally rectangular configuration.

The embodiment shown in the present invention is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A device for shielding an animal, the device comprising:
(a) a harness adapted to be releasably secured to the animal, and
(b) an umbrella coupled to the harness.

2. The device as claimed in claim 1 wherein the umbrella is removably coupled to the harness.

3. The device as claimed in claim 1 wherein the umbrella comprises:
(a) an elongated handle, the handle having a first end and a second end, and
(b) a canopy fixedly coupled to the second end of the handle.

4. The device as claimed in claim 3 wherein the harness comprises:
(a) an elongated dorsal strip adapted to be mounted on the animal, the dorsal strip including a top surface, a bottom surface, a first end and a second end, and
(b) a holder extending from the top surface of the dorsal strip, the holder being dimensioned to fittingly receive the first end of the handle of the umbrella.

5. The device as claimed in claim 4 wherein the holder is in the form of a hollow, tubular member which is shaped to define an opening

6. The device as claimed in claim 5 wherein the handle additionally includes a bottom spring which is sized and shaped to project through the opening in the holder when the umbrella is coupled to the harness.

7. The device as claimed in claim 3 wherein the canopy comprises:
(a) an enlarged sheet of water-proof fabric, and
(b) a rigid frame secured to the sheet along at least portion of its periphery.

8. The device as claimed in claim 7 wherein the enlarged sheet has a non-circular configuration.

9. The device as claimed in claim 7 wherein the enlarged sheet has a length of approximately 24 inches and a width of approximately 7 inches.

10. The device as claimed in claim 7 wherein the enlarged sheet includes a top surface, a bottom surface and a transverse fold line through which the enlarged sheet can be folded in half.

11. The device as claimed in claim 7 wherein the rigid frame comprises:
(a) a plurality of connectors affixed to the enlarged sheet at various points along its periphery,
(b) an array of elongated, support members attached to the plurality of connectors,
(c) a collar slidably mounted over the handle, and
(d) a pair of stretchers, each stretcher connecting the collar to at least one of the plurality of connectors.

12. The device as claimed in claim 4 wherein the harness additionally comprises a posterior strap which is connected to the second end of the dorsal strip.

13. The device as claimed in claim 12 wherein the posterior strap is adapted to be formed into a closed loop that wraps firmly around the abdomen of the animal.

14. The device as claimed in claim 13 wherein the posterior strap is constructed from a strip of stretchable material.

15. The device as claimed in claim 13 wherein the posterior strap is releasably retained in its closed loop configuration using a complementary pair of releasable fasteners.

16. The device as claimed in claim 4 wherein the harness additionally comprises an anterior strap which is connected to the first end of the dorsal strip.

17. The device as claimed in claim 16 wherein the anterior strap is adapted to be formed into a closed loop that wraps firmly around a collar worn on the neck of the animal.

18. The device as claimed in claim 17 wherein the anterior strap is constructed from a strip of stretchable material.

19. The device as claimed in claim 18 wherein the anterior strap is releasably retained in its closed loop configuration using a complementary pair of releasable fasteners.
